(19) United States
(12) Patent Application Publication
(10) Pub. No.: US 2016/0230938 A1
(43) Pub. Date: Aug. 11, 2016

(54) OMNIDIRECTIONAL LIGHT-EMITTING DIODE LIGHT BULB

(71) Applicant: CROWNMATE TECHNOLOGY CO., LTD., Taipei City (TW)

(72) Inventor: Li-Chuh CHANG, Taipei City (TW)

(73) Assignee: CROWNMATE TECHNOLOGY CO., LTD., Taipei City (TW)

(21) Appl. No.: 14/618,152

(22) Filed: Feb. 10, 2015

(51) Int. Cl. F21K 99/00; F21V 17/12; F21V 23/02; F21V 17/10

(52) U.S. Cl. CPC F21K 9/135; F21K 9/50; F21V 17/10; F21V 17/12; F21V 17/101; F21V 23/023; F21Y 2101/02

(57) ABSTRACT

An omnidirectional LED light bulb includes a lighting cover, a main body, and a base. The lighting cover includes upper and lower covers, which are coupled together through first and second coupling sections formed on the upper and lower covers to form a bottom-open cover. The upper cover has an interior surface including a plurality of concentric engraved circular patterns circling around a center of the upper cover. The first and second coupling sections are coupled together in a completely sealed manner. The main body includes a casing receiving therein a power module and coupled to the lower cover with a sealing ring interposed therebetween. The casing has a top on which a lighting plate including light-emitting elements is mounted and electrically connected to the power module. The base is coupled to the main body.

### FIELD OF THE INVENTION

The present invention relates to a light-emitting diode (LED) light bulb, and in particular to an omnidirectional LED light bulb, which comprises a lighting cover that has an interior surface on which regular minute planar faces are formed through cutting in tangential directions so that light from light sources that are arranged by following a plane is reflected by the minute planar faces to become randomly projected thereby spreading effective lighting to a space rearwards of the light sources so as to achieve an effect of light refraction along a full perimeter thereof.

### BACKGROUND OF THE INVENTION

Contemporarily, LEDs have been widely used in electronic devices and even consumer products. LEDs have taken the place of the traditional light bulbs for LEDs have various advantages, such as small size, fast response, low power consumption, and long lifespan. Among all the products, lighting fixture products are one that is the greatest in number for using LEDs. A general lighting fixture comprises a base, at least a light holder, and at least a light bulb. To save energy and reduce carbon and also to comply with the contemporary environmental conservation policy, LED light bulbs have been used to replace the traditional tungsten filament light bulbs. However, the conventional LED light bulbs are made of glass and to dissipate the heat generated in the interior of the LED, a base contact that is formed at a bottom of the light bulb is combined with a heat dissipation element. This makes the conventional LED light bulb disadvantageous in various aspects.

Firstly, the light bulb is made of glass and is thus fragile and dangerous and also counts for a heavy weight. Secondly, the light bulb and the bottom base contact are bonded by applying adhesive therebetween, making the sealability poor so that when used outdoors or in a specific working environment, it may be easily invaded by humidity or corrosive gas (such as ammonia gas and hydrogen sulfide gas) that causes problems of unexpected electric shocks or damage and failure of internal circuit and components thereof. Further, since LEDs have high directivity, they are hard to be used in situations where a wide range of illumination may be needed. To achieve omnidirectional lighting, reflection or direct illumination of the light from the LEDs are required for illuminating the surrounding, or alternatively, a light exit surface may be extended to provide a structure that achieves omnidirectional lighting. This requires an increase of cost and parts. In applications where the light bulb is installed in a moving site, then the light may violently shaken, leading the deterioration of reliability and stability, or alternatively, the number of parts accommodated in the light bulb may be increased, making the outline design expanded.

In view of the above, the present invention aims to provide an improved design of an omnidirectional LED light bulb, which effectively eliminates the above-discussed problems.

### SUMMARY OF THE INVENTION

An object of the present invention is to provide an omnidirectional light-emitting diode (LED) light bulb, which comprises an LED serving as a spot light source showing the characteristics of linearity, whereby through precise and accurate calculation of the structure of a lighting cover, the wideness of a projection range can be increased. Further, compared to the traditional incandescent light bulbs, LEDs have relatively long lifespan and save more power, allowing for commercialization of LED light bulbs.

Another object of the present invention is to provide a design of a completely sealed structure, which is usable in a location where there is a large amount of humidity and corrosive gases, wherein the completely sealed structure prevent gases and humidity from penetrating into the interior of the omnidirectional LED light bulb of the present invention, helping increase reliability and stability.

To achieve the above objects, the present invention provides an n omnidirectional light-emitting diode (LED) light bulb, which generally comprises a lighting cover, a main body, and a base. The lighting cover comprises an upper cover and a lower cover coupled together to form a bottom-open cover. The upper cover has an interior surface that comprises a plurality of concentric engraved circular patterns formed therein to circle around a center of the upper cover. The upper cover has a bottom edge that forms a first coupling section. The lower cover having a top edge forming a second coupling section. The first coupling section is coupled to the second coupling section in a completely sealed manner. The lower cover has a bottom flange in which a plurality of holes is formed.

In addition, the main body comprises a housing in which a power module is arranged. The housing has a top, which, together with the lower cover, receive a sealing ring therebetween and is securely jointed by a plurality of fasteners connecting the holes. The top of the housing comprises a lighting plate mounted thereon. The lighting plate comprises a plurality of light-emitting elements and is electrically connected to the power module. Further, the base is coupled to the main body in an electrically insulated manner.

In an embodiment of the present invention, the concentric engraved circular patterns have a spacing distance that shows a predetermined proportional relationship with respect to quantity and locations of the light-emitting elements and thickness and light transmittance of the lighting cover.

In an embodiment of the present invention, the concentric engraved circular patterns are made through a predetermined machining process based on accurate calculation in order to enhance light diffusion and light distribution of the lighting cover.

In an embodiment of the present invention, the concentric engraved circular patterns are formed by fine cutting in the vertical direction and the spacing distance between the concentric engraved circular patterns is calculated to be in alignment with sizes of an outside diameter curve of the upper cover and each intersection point so as to form a curved surface of assembly of straight lines.

In an embodiment of the present invention, the upper cover has a central portion that forms a central section, the central section being formed a lens structure in order to increase illumination of the central section.

In an embodiment of the present invention, the first coupling section and the second coupling section are respectively of mated recessed and raised structures, the recessed and raised structures being fit to each other and joined through ultrasonic or high frequency fusion to improve fusion strength and seal strength.

In an embodiment of the present invention, the lower cover has an interior surface that comprises concentric engraved circular patterns formed thereon and corresponding to the upper cover to refract reflection light from the upper cover.

In an embodiment of the present invention, the base is a casing in the form of insulation cylinder, the base having a lower portion having a circumferential surface in a threaded form, the base having a top coupled to a bottom of the main body with a separation plate arranged therebetween, the base and the main body being securely coupled through application of adhesive and screwing joint.

In an embodiment of the present invention, the fasteners are bolts that threadingly couple the lower cover to a top of the main body.

In an embodiment of the present invention, the power module further comprises a power supply cover, which is arranged between the power module and the lighting plate to isolate thermal transfer therebetween.

In an embodiment of the present invention, the main body is made of an aluminum alloy or a material of high thermal conductivity, wherein with the aluminum alloy or the high thermal conductivity material in contact with external air, heat is dissipated from the lighting plate.

### BRIEF DESCRIPTION OF THE DRAWINGS

The present invention will be apparent to those skilled in the art by reading the following description of preferred embodiments thereof with reference to the drawings, in which:

FIG. 1 is a perspective view showing an omnidirectional LED light bulb according to the present invention;

FIG. 2 is a perspective view showing an upper cover of the omnidirectional LED light bulb according to the present invention;

FIG. 3 is a schematic view showing the omnidirectional LED light bulb according to the present invention;

FIG. 4 is a cross-sectional view showing the omnidirectional LED light bulb according to the present invention;

FIG. 5 is an enlarged view of a portion of the omnidirectional LED light bulb according to the present invention;

Exhibition 1A illustrates light distribution of a conventional LED light bulb;

Exhibition 1B illustrates light distribution of the omnidirectional LED light according to the present invention; and

Exhibition 2 illustrates a cross-sectional view of the upper cover of the omnidirectional LED light bulb according to the present invention.

### DETAILED DESCRIPTION OF THE PREFERRED EMBODIMENTS

The present invention provides an omnidirectional LED light bulb, which uses a light-emitting diode (LED) as a spot light source showing characteristics of linearity, which in combination with accurate and precise calculation of concentric engraved circular patterns of a lighting cover, the lighting cover, and light-emitting elements, enhances the width of illumination range and refraction and reflection strength to form an ultra-wide angle omnidirectional LED light bulb structure.

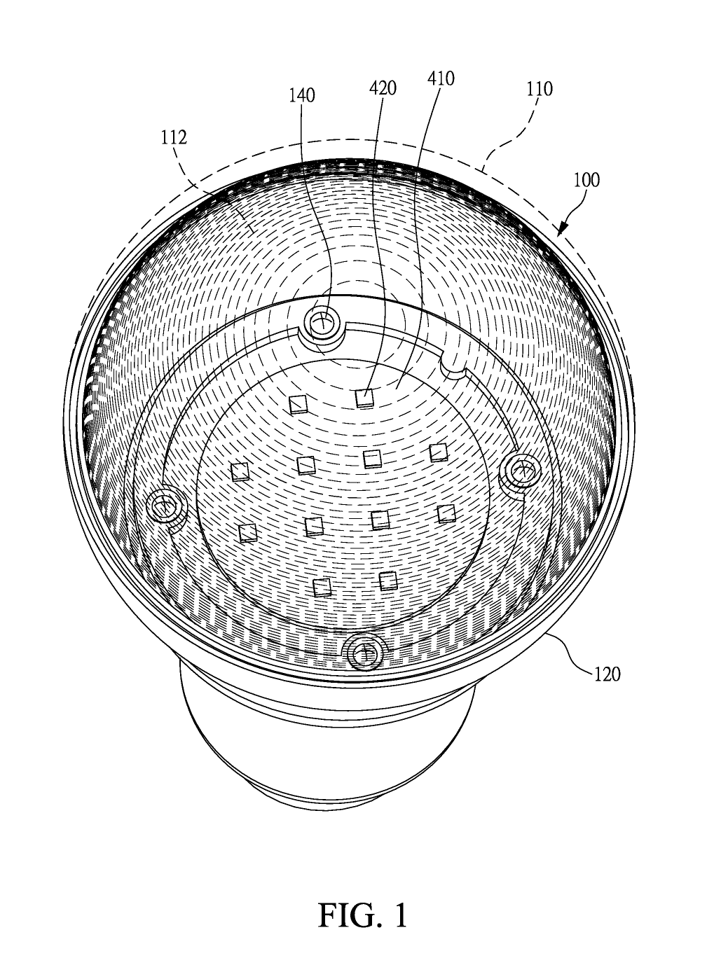

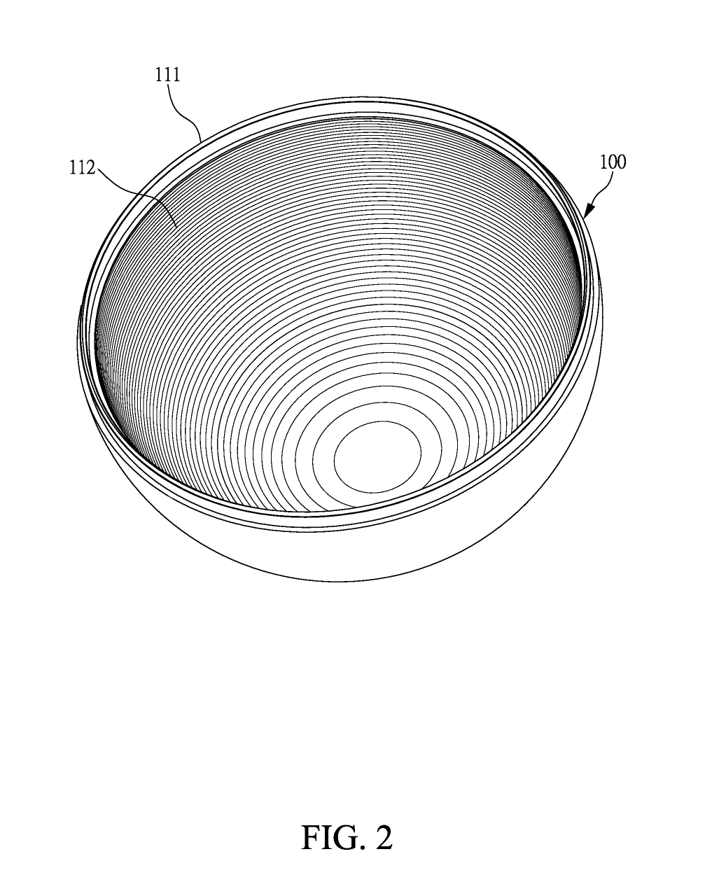

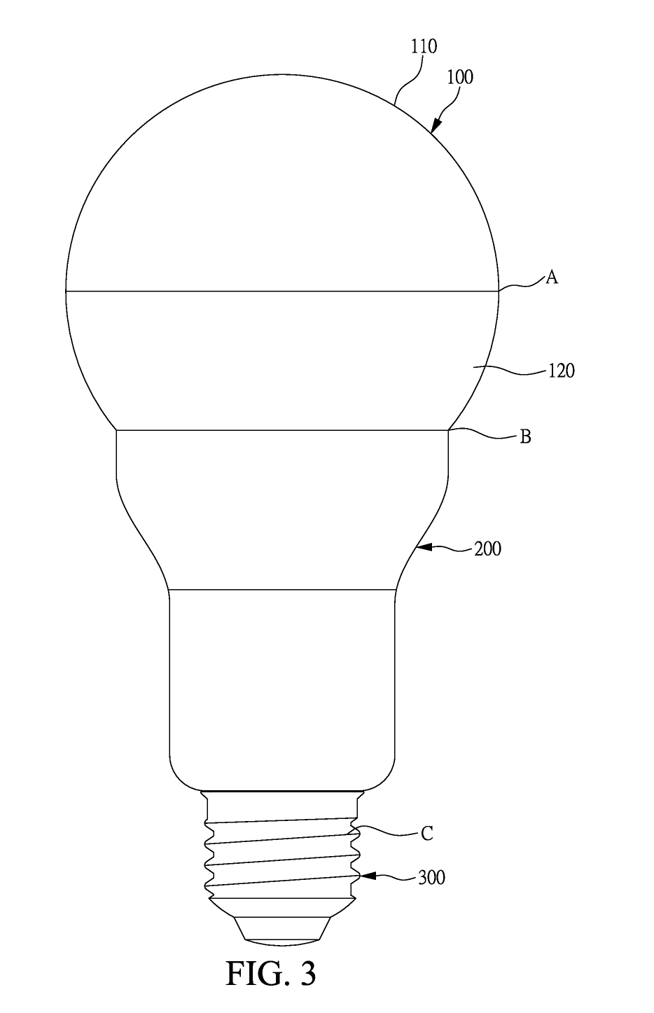

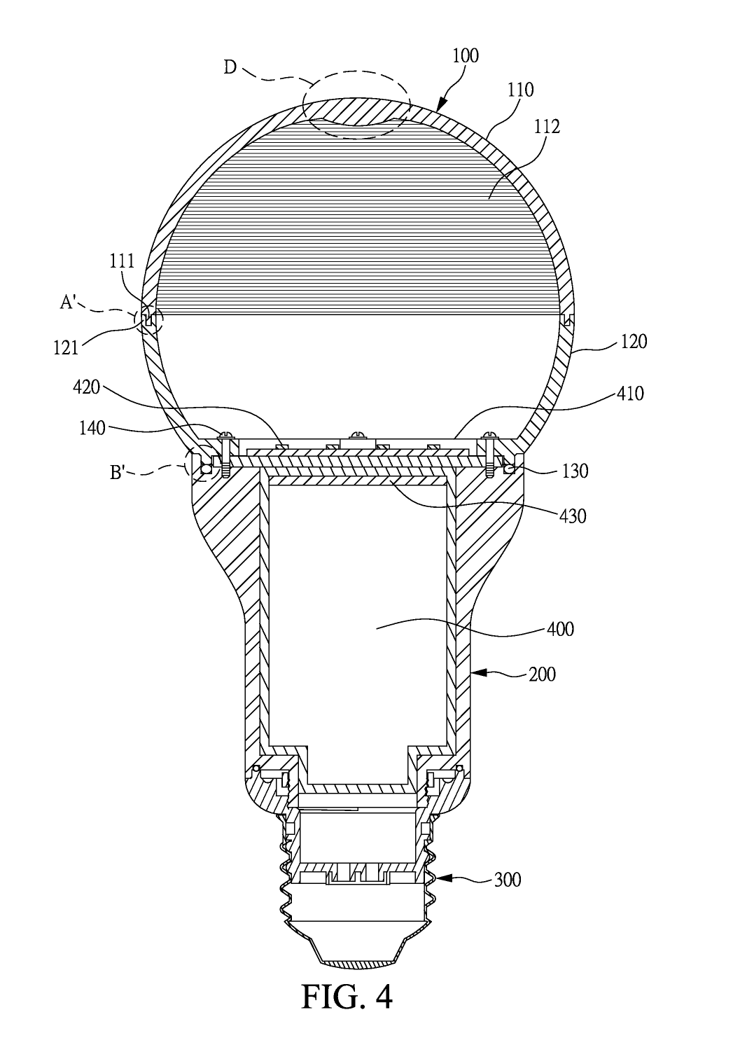

Referring to FIGS. 3 and 4, which are respectively a schematic view and a cross-sectional view of an omnidirectional LED light bulb according to the present invention, the present invention provides an omnidirectional LED light bulb, which comprises a lighting cover 100, a main body 200, and a base 300. The lighting cover 100 is composed of an upper cover 110 and a lower cover 120, which are coupled to each other by engagement between a first coupling section 111 of the upper cover 110 and a second coupling section 121 of the lower cover 120 to form a cover having a bottom opening. The upper cover 110 has an interior surface that comprises a plurality of concentric engraved circular patterns 112 formed therein to concentrically circle around a center of the upper cover (as shown in FIG. 2). The first coupling section 111 and the second coupling section 121 are coupled together in a completely sealed manner to form a joint A. The main body 200 is made in the form of a housing in which a power module 400 is formed and which interposes a sealing ring 130 with respect to the lower cover 120. A plurality of fasteners 140, received through holes, is used to achieve tight coupling. The fasteners can be bolts that threadingly couple the lower cover to a top of the main body. As shown in FIGS. 1 and 4, the top of the main body 200 comprises a lighting plate 410 mounted thereon. The lighting plate 410 comprises a plurality of light-emitting elements 420 and is electrically connected to the power module 400. The base 300 is attached to the main body 200 in a manner of being electrically insulated from each other.

Spacing distance between the concentric engraved circular patterns has a specific proportional relationship with respect to the quantity and the locations of the light-emitting elements and thickness and light transmittance of the lighting cover. Referring to Exhibitions 1A and 1B, accurate calculation and determination of the relationship among the three provides a desired arrangement of the concentric engraved circular patterns, which in combination with refraction and reflection of light, makes light diffused in upward and downward directions to achieve optimum light distribution and wide angle.

As illustrated in Exhibitions 1A and 1B, Exhibition 1A illustrates light distribution of a conventional LED light bulb and Exhibition 1B illustrates light distribution of the omnidirectional LED light bulb according to the present invention. It can be seen that illumination direction achieved with the conventional LED light bulb is generally in a direction toward the lighting cover 100 with a minor portion reflected toward main body 200. In other words, as shown in Exhibition 1A, when a conventional LED light bulb gives off light, the light is generally concentrated in the upper portion E, while a minor portion is reflected to the lower portion F. However, on the interior surface of the upper cover of the lighting cover 100 according to the present invention, the curved surface is provided with regular minute planar faces, which constitute the concentric engraved circular pattern, arranged according to the quantity and arranged locations of the light-emitting elements and the light transmittance and thickness of the lighting cover by applying cutting in tangential directions so that the illuminating light from the light-emitting elements, in an amount of around 30%, become randomly projected generally consistently in a direction toward the main body 200, exceeding beyond the limit of light exit angle of the light-emitting elements to reach a light exit angle of more than 180 degrees for effective lighting, so as to effectively increase the overall width and brightness of the outward projection of light, as illustrated in Exhibition 1B. As compared to Exhibition 1A, the present invention can enhance uniform distribution of light and omnidirectional lighting.

In a practical application, the lower cover may be provided, on an interior surface thereof, with concentric engraved circular patterns corresponding to those of the upper cover in order to enhance refraction of the light reflected from the upper cover. Referring to Exhibition 2, a cross-sectional view of the upper cover of the omnidirectional LED light bulb according to the present invention is provided. The concentric engraved circular patterns are formed by applying a specific machining process based on accurate calculation in order to enhance light diffusion and light distribution of the lighting cover. The concentric engraved circular patterns are formed by fine cutting in the vertical direction and the spacing distance between the concentric engraved circular patterns is calculated to be in alignment with sizes of an outside diameter curve of the upper cover and each intersection point so as to form a curved surface of assembly of straight lines.

More specifically, referring to FIG. 4 and Exhibition 2, the upper cover 110 has a central portion that forms a central section D. The central section D is designed to form a lens structure in order to increase illumination of the central section D, which, in combination with the thickness of the lighting cover 100 that is subjected to accurate calculation to be in alignment with the sizes of the outside diameter curve of the upper cover 110 and each intersection point, increases the overall reflection and diffusion of light of lighting cover 100. In a practical application, the surface of the mold for making the inside of the upper cover, without any additional parts, can solely make the inside of the upper cover naturally form light transmittance and reflection light, which in combination with cutting size unit in the vertical direction, and based on the sizes and locations of LED, the size of the lighting cover, and the desired characteristics of omnidirectional lighting, to calculate a most fit value, there being a difference, the value being adjusted according to practical needs, the cutting size being between 0.5 mm-1.5 mm.

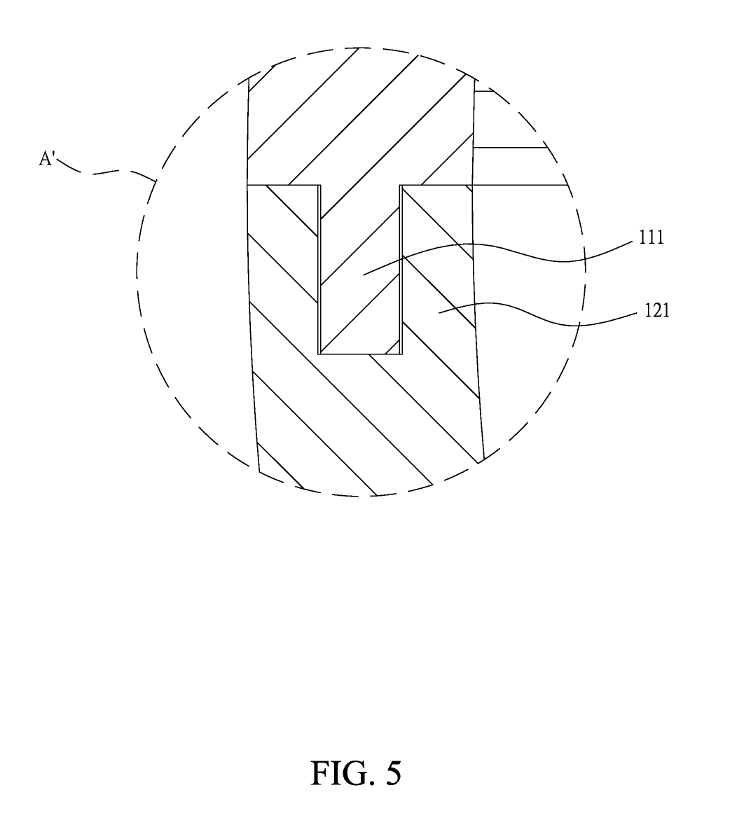

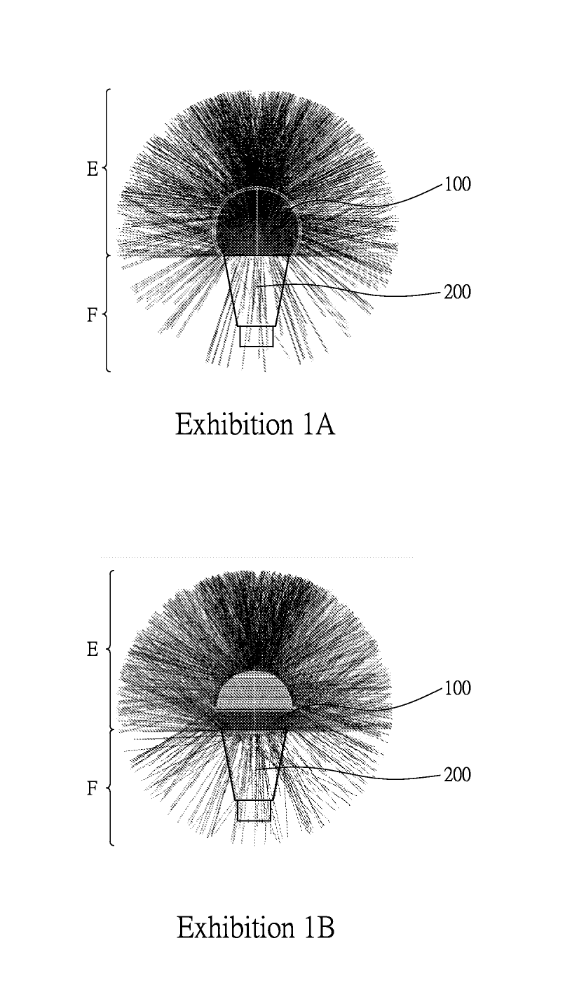

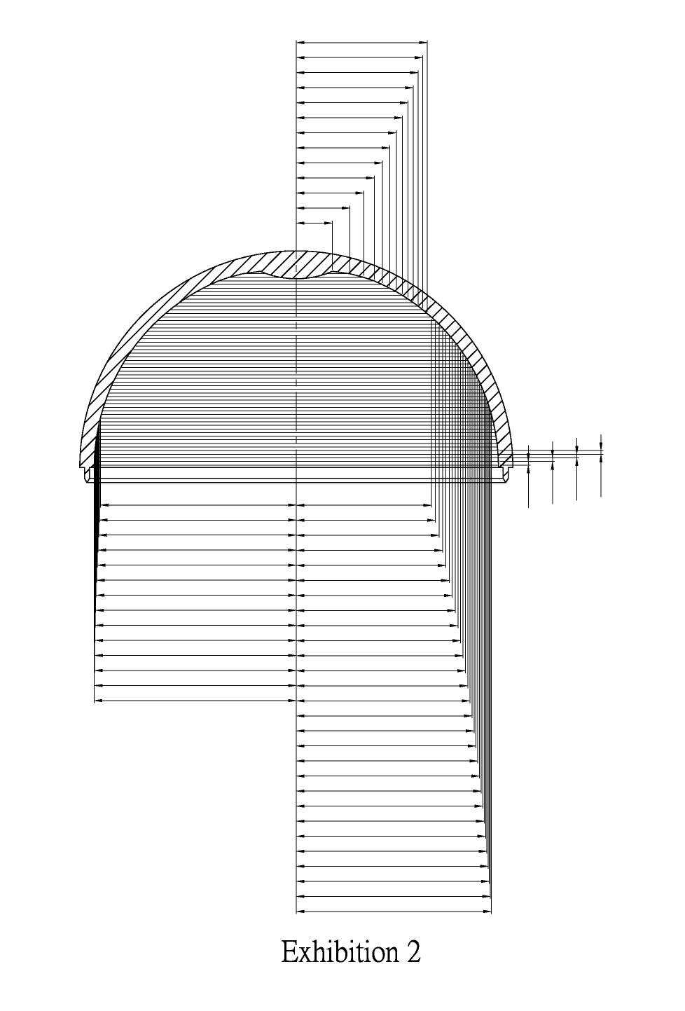

Referring to FIGS. 3-5, the connections of joint A, joint B, and joint C will be described. Firstly, as shown in FIGS. 4 and 5, which are a cross-sectional view and an enlarged view of a portion of the omnidirectional LED light bulb according to the present invention. In the enlarged portion A′, the first coupling section 111 and the second coupling section 121 are respectively of mated recessed and raised structures. The mated recessed and raised structures are fit to each other and joined through ultrasonic or high frequency fusion to ensure the overall fusion strength and seal strength of the lighting cover.

Next, as shown in FIGS. 3 and 4, the portion B′ is the joint B of the lower cover 120 and the main body 200. In a practical application, they can be mated engagement structures, which can be mated recessed and raised structures or a grooved structure with a sealing ring 130 received therein to enhance mating therebetween and being applied with an adhesive to form a completely waterproof airtight structure. Finally, in a practical application, the base 300 is a casing in the form of insulation cylinder. The base 300 has a lower portion having a circumferential surface in a threaded form. The base 300 has a top coupled to a bottom of the main body 200 with a separation plate (not shown) arranged therebetween. The base 300 and the main body 200 are securely coupled through application of adhesive and screwing joint.

As shown in FIG. 4, the power module 400 further comprises a power supply cover 430, which is arranged between the power module 400 and the lighting plate 410 to isolate thermal radiation between them. Further, the main body 200 is made of an aluminum alloy or a material having high thermal conductivity so that with the aluminum alloy or the high thermal conductivity material in contact with external air, heat can be dissipated from the lighting plate 410. Compared to the conventional techniques, no heat dissipation fin structure is needed so that the present invention provides a structure that allows for easy cleaning of the surface of the main body and has overall electric safety.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An omnidirectional light-emitting diode (LED) light bulb, which comprises at least:
a lighting cover, which comprises an upper cover and a lower cover coupled together to form a bottom-open cover, the upper cover having an interior surface that comprises a plurality of concentric engraved circular patterns formed therein to circle around a center of the upper cover;
the upper cover having a bottom edge that forms a first coupling section, the lower cover having a top edge forming a second coupling section, the first coupling section being coupled to the second coupling section in a completely sealed manner, the lower cover having a bottom flange in which a plurality of holes is formed;
a main body, which comprises a housing in which a power module is arranged, the housing having a top, which, together with the lower cover, receive a sealing ring therebetween and is securely jointed by a plurality of fasteners connecting the holes, the top of the housing comprising a lighting plate mounted thereon, the lighting plate comprising a plurality of light-emitting elements and electrically connected to the power module; and a base, which is coupled to the main body in an electrically insulated manner.

2. The omnidirectional LED light bulb as claimed in claim 1, wherein the concentric engraved circular patterns have a spacing distance that shows a predetermined proportional relationship with respect to quantity and locations of the light-emitting elements and thickness and light transmittance of the lighting cover.

3. The omnidirectional LED light bulb as claimed in claim 1, wherein the concentric engraved circular patterns are made through a predetermined machining process based on accurate calculation in order to enhance light diffusion and light distribution of the lighting cover.

4. The omnidirectional LED light bulb as claimed in claim 1, wherein the concentric engraved circular patterns are formed by fine cutting in the vertical direction and the spacing distance between the concentric engraved circular patterns is calculated to be in alignment with sizes of an outside diameter curve of the upper cover and each intersection point so as to form a curved surface of assembly of straight lines.

5. The omnidirectional LED light bulb as claimed in claim 1, wherein the upper cover has a central portion that forms a central section, the central section being formed a lens structure in order to increase illumination of the central section.

6. The omnidirectional LED light bulb as claimed in claim 1, wherein the first coupling section and the second coupling section are respectively of mated recessed and raised structures, the recessed and raised structures being fit to each other and joined through ultrasonic or high frequency fusion to improve fusion strength and seal strength.

7. The omnidirectional LED light bulb as claimed in claim 1, wherein the lower cover has an interior surface that comprises concentric engraved circular patterns formed thereon and corresponding to the upper cover to refract reflection light from the upper cover.

8. The omnidirectional LED light bulb as claimed in claim 1, wherein the base is a casing in the form of insulation cylinder, the base having a lower portion having a circumferential surface in a threaded form, the base having a top coupled to a bottom of the main body with a separation plate arranged therebetween, the base and the main body being securely coupled through application of adhesive and screwing joint.

9. The omnidirectional LED light bulb as claimed in claim 1, wherein the fasteners are bolts that threadingly couple the lower cover to a top of the main body.

10. The omnidirectional LED light bulb as claimed in claim 1, wherein the power module further comprises a power supply cover, which is arranged between the power module and the lighting plate to isolate thermal transfer therebetween.
